(19) United States
(12) Patent Application Publication
(10) Pub. No.: US 2022/0198327 A1
(43) Pub. Date: Jun. 23, 2022

(54) METHOD, APPARATUS, DEVICE AND STORAGE MEDIUM FOR TRAINING DIALOGUE UNDERSTANDING MODEL

(71) Applicant: BEIJING BAIDU NETCOM SCIENCE AND TECHNOLOGY CO., LTD., Beijing (CN)

(72) Inventors: Shuohuan WANG, Beijing (CN); Chao PANG, Beijing (CN); Yu SUN, Beijing (CN)

(73) Assignee: BEIJING BAIDU NETCOM SCIENCE AND TECHNOLOGY CO., LTD., Beijing (CN)

(21) Appl. No.: 17/348,270

(22) Filed: Jun. 15, 2021

(30) Foreign Application Priority Data
Dec. 18, 2020 (CN) 202011503354.X

(51) Int. Cl. G06N 20/00; G06N 5/02; G10L 25/54; G10L 25/27; G06F 16/9032; G06F 16/907

(52) U.S. Cl. CPC G06N 20/00; G06N 5/02; G06F 16/907; G10L 25/27; G06F 16/90332; G10L 25/54

(57) ABSTRACT

The present disclosure provides a method, apparatus, device and storage medium for training a dialogue understanding model, and relates to technical field of computers, and specifically to the technical field of artificial intelligence such as natural language processing and deep learning. The method for training a dialogue understanding model includes: obtaining dialogue understanding training data; performing joint training for a dialogue understanding pre-training task and a general pre-training task by using the dialogue understanding training data, to obtain a dialogue understanding model. According to the present disclosure, a model specially adapted for a dialogue understanding task may be obtained by training.

### CROSS-REFERENCE TO RELATED APPLICATIONS

The present application claims the priority of Chinese Patent Application No. 202011503354.X, filed on Dec. 18, 2020, with the title of “Method, apparatus, device and storage medium for training dialogue understanding model.” The disclosure of the above application is incorporated herein by reference in its entirety.

### TECHNICAL FIELD

The present disclosure relates to technical field of computers, and specifically to the technical field of artificial intelligence such as natural language processing and deep learning, and particularly to a method, apparatus, device and storage medium for training a dialogue understanding model.

### BACKGROUND

Natural Language Processing (NLP) is a cross-technology involving computer science, artificial intelligence (AI) and linguistics, and aims to enable computers to process or “understand” natural language to perform a task such as language translation and question and answer. As speech interfaces and chatbots arise, NLP has become one of the most important technologies in the information age and an important part of artificial intelligence.

Natural Language Understanding (NLU) is an important part of NLP. A core task of NLU is to transform a natural language into a formal language that may be processed by a machine, and establish a connection between the natural language and resources and services. NLU may be divided into two tasks, namely, intent classification and slot labeling. NLU generally achieves intent classification and slot labeling based on a pre-trained semantic understanding model.

In relevant technologies, the semantic understanding model used is generally a general semantic understanding model which is obtained using general training data based on a general pre-training task.

### SUMMARY

The present disclosure provides a method, apparatus, device, storage medium and program product for training a dialogue understanding model.

According to an aspect of the present disclosure, there is provided a method for training a dialogue understanding model, including: obtaining dialogue understanding training data; performing joint training for a dialogue understanding pre-training task and a general pre-training task by using the dialogue understanding training data, to obtain a dialogue understanding model.

According to another aspect of the present disclosure, there is provided an electronic device, including: at least one processor; and a memory communicatively connected with the at least one processor; wherein the memory stores instructions executable by the at least one processor, and the instructions are executed by the at least one processor to enable the at least one processor to perform a method for training a dialogue understanding model, wherein the method includes: obtaining dialogue understanding training data; performing joint training for a dialogue understanding pre-training task and a general pre-training task by using the dialogue understanding training data, to obtain a dialogue understanding model.

According to a further aspect of the present disclosure, there is provided anon-transitory computer readable storage medium with computer instructions stored thereon, wherein the computer instructions are used for causing a computer to perform a method for training a dialogue understanding model, wherein the method includes: obtaining dialogue understanding training data; performing joint training for a dialogue understanding pre-training task and a general pre-training task by using the dialogue understanding training data, to obtain a dialogue understanding model.

According to technical solutions of the present disclosure, a model specially adapted for the dialogue understanding task may be obtained by training with the dialogue understanding training data and by performing the training of the dialogue understanding pre-training task upon task training.

It will be appreciated that the Summary part does not intend to indicate essential or important features of embodiments of the present disclosure or to limit the scope of the present disclosure. Other features of the present disclosure will be made apparent by the following description.

### BRIEF DESCRIPTION OF THE DRAWINGS

The figures are intended to facilitate understanding the solutions, not to limit the present disclosure. In the figures,

FIG. 1 illustrates a schematic diagram of a first embodiment according to the present disclosure;

FIG. 2 illustrates a schematic diagram of a second embodiment according to the present disclosure;

FIG. 3 illustrates a schematic diagram of a third embodiment according to the present disclosure;

FIG. 4 illustrates a schematic diagram of a fourth embodiment according to the present disclosure;

FIG. 5 illustrates a schematic diagram of a fifth embodiment according to the present disclosure;

FIG. 6 illustrates a schematic diagram of a sixth embodiment according to the present disclosure;

FIG. 7 illustrates a schematic diagram of a seventh embodiment according to the present disclosure;

FIG. 8 illustrates a schematic diagram of an eighth embodiment according to the present disclosure;

FIG. 9 illustrates a schematic diagram of a ninth embodiment according to the present disclosure;

FIG. 10 illustrates a schematic diagram of a tenth embodiment according to the present disclosure;

FIG. 11 illustrates a schematic diagram of an electronic device for implementing any of a method for training a dialogue understanding model and a dialogue understanding method according to embodiments of the present disclosure.

### DETAILED DESCRIPTION

Exemplary embodiments of the present disclosure are described below with reference to the accompanying drawings, include various details of the embodiments of the present disclosure to facilitate understanding, and should be considered as being only exemplary. Therefore, those having ordinary skill in the art should recognize that various changes and modifications can be made to the embodiments described herein without departing from the scope and spirit of the application. Also, for the sake of clarity and conciseness, depictions of well-known functions and structures are omitted in the following description.

Along with rapid development of AI technology, more and more products and applications such as intelligent service, intelligent assistant, onboard navigation and intelligent home begin to attempt to introduce a dialog-type human-machine interaction manner. However, in practical work, development of a dialog system is a very difficult job for most developers, wherein one major technical difficulty is query understanding, namely, natural language understanding. The core task of query understanding is to transform a natural language into a formal language that may be processed by a machine, and establish a connection between the natural language and resources and services.

The process of query understanding may be divided into intent classification and slot labelling, wherein intent classification means that regarding a certain query, the machine offers the intent of the query; slot labelling means that the machine offers a corresponding parameter value under the intent. For example, query=“help me to book a train ticket from Beijing to Tianjin”; query=“I want to leave Beijing for Tianjin by train”. The two queries both mean that the user wants to “book a train ticket” with the departure being “Beijing” and destination being “Tianjin”. That is, the intent classification is “booking a train ticket”, and the slot labeling includes: “departure=Beijing” and “Destination=Tianjin”.

In the relevant technologies, intent classification and slot labelling may be accomplished based on a pre-trained semantic understanding model. The semantic understanding model may be achieved based on a conventional pre-training model. A conventional pre-training model is for example a Bidirectional Encoder Representations from Transformers (BERT) model, an Enhanced Representation from kNowledge IntEgration (ERNIE) model, etc. The NLP technology level may be substantially enhanced in a pre-training+fine tuning manner.

In the relevant technologies, the general semantic understanding model may also be achieved based on a pre-training model such as BERT or ERNIE, and it generally uses a top layer representation at [CLS] position of BERT to classify domain or intent, and then uses a position of each character for classification to perform slot labelling. However, the general semantic understanding model uses general corpus (e.g., data such as encyclopedia or news), and its corpus and model structure are not adapted specially. Meanwhile, a target of a general pre-training task such as a mask prediction task does not match a target (intent classification and slot labelling) of the dialogue understanding, which limits an application effect of the pre-training technology and reduces a dialogue understanding effect.

To address the problem regarding no adaptation to a dialogue understanding task and an undesirable dialogue understanding effect in the above technology, the present disclosure provides some embodiments to specially adapt to the dialogue understanding task and enhance the dialogue understanding effect.

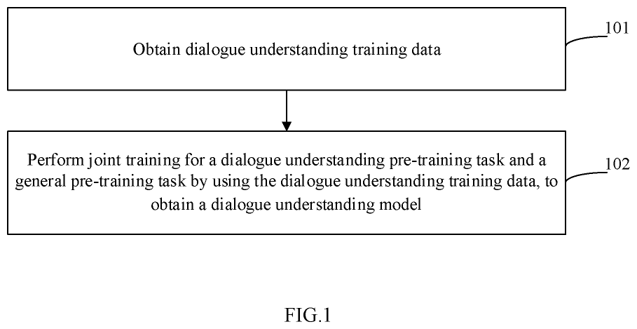

FIG. 1 illustrates a schematic diagram of a first embodiment according to the present disclosure. This embodiment provides a method for training a dialogue understanding model, comprising:

101: obtaining dialogue understanding training data.

102: performing joint training for a dialogue understanding pre-training task and a general pre-training task by using the dialogue understanding training data, to obtain a dialogue understanding model.

Step 101 is illustrated below:

In the relevant technologies, the general semantic understanding model is obtained by training with general corpus (e.g., data such as encyclopedia or news), and by employing a training task which is also a general task (e.g., a mask prediction task of the BERT model). Therefore, the general semantic understanding model cannot be well adapted for the dialogue understanding task, and reduces the dialogue understanding effect.

In the embodiment of the present disclosure, some dialogue understanding training data adapted for the dialogue understanding task will be specially configured, to train the model specially adapted for the task understanding task.

The dialogue understanding pre-training task may include: an intent pre-training task, and/or, a slot pre-training task. The dialogue understanding training data from different sources may be obtained according to different dialogue understanding pre-training task. For example, as for an intent pre-training task, the dialogue understanding training data may be obtained based on search engine data; as for a slot pre-training task, the dialogue understanding training data may be obtained based on a knowledge graph.

The dialogue understanding training data may include: corpus data and tag data.

Specifically, if the dialogue understanding pre-training task includes an intent pre-training task, the corpus data includes a first query; the tag data includes a name of a website clicked by the user and corresponding to the first query; and/or, if the dialogue understanding pre-training task includes a slot pre-training task, the corpus data includes a second query; the tag data includes: a corresponding hypernym of each character in the second query in the knowledge graph.

The search engine data refers to data generated based on the search engine and includes a query and a name of a website clicked by the user and corresponding to the query.

The user inputs the query in the search engine, and the search engine returns a search result which is for example a website link, to the user. The user may view a desired result based on the search result returned by the search engine, for example, the user clicks the website link to be viewed. The search engine generates 100 million-order queries searched by users every day. These queries generally look up for specific website links, and the language forms of these queries are similar to query forms in the dedicated domains: requests for specific resources or services. The query, especially the query of the mobile terminal, is generally very colloquial and adapted to serve as dialogue understanding training data for dialogue understanding. In addition, the user's click behavior has a very strong intent directivity, and the click behaviors based on these queries may also serve as weakly-supervised tag data. Table 1 shows correspondence relationship between several queries and website names. Hence, the search engine data for example include the queries and corresponding website names shown in Table 1.

TABLE 1

| Website names | Queries | | |
|---|---|---|---|
| www.haotq.com | Hourly weather | Weather | 24-hour |
| | conditions of | conditions in | weather |
| | Harbin | one future | conditions of |
| | | month | Taixing |
| spk.39.net | Does Chinese | What nutrition | Function and |
| | yam promote | do cooked | efficacy of |
| | blood | Chicken | oval |
| | circulation? | claws have? | kumquat |
| www.idp.cn | How to print | Ranking of | Top 100 tuition |
| | a test | US piano | fees for |
| | achievement of | schools | studying |
| | TOEFL? | | abroad |

Therefore, after a lot of search engine data are collected, TopN (N is a constant, for example, 20000) website names may be selected, and queries corresponding to the selected website names may be obtained. Correspondingly, in the training phase, a corresponding intent pre-training task may include: taking the query as input to the model, and using the dialogue understanding model to predict a website name corresponding to the query. A CLS position is used to predict the intent. The intent pre-training task is trained so that the dialogue understanding model has an intent understanding capability in the pre-training phase.

Knowledge graph is referred to as knowledge domain visualization or knowledge domain mapping map in the field of library and information, is a series of various different graphs showing knowledge development progress and structural relationship, and uses visualization techniques to describe knowledge resources and their carriers, and mine, analyze, build, draw and display knowledge and mutual relationship therebetween.

Knowledge graph stores a lot of knowledge in the form of a triplet, wherein the typical triplet knowledge is hypernym-hyponym relationship (isA). These data indicate a hypernym of a word. For example, a hypernym of apple is fruit, and a hypernym of A Dream of Red Mansions is novel, TV serial, movie etc. Words sharing the same hypernym may be considered as being in the same class. The information of the hypernym is closely relevant to the slot in the dialogue understanding. For example, the hypernym of “Beijing” and “Shanghai” is “location”. Regarding intelligent services for clients upon booking train tickets, “location” is very probably the slot of “departure” and “destination”. Regarding an intelligent sound box for querying for weather forecast, “location” is very probably the slot for “querying for a city”.

Therefore, in the training phase, after the query is obtained, the corresponding slot pre-training task may include: taking the query as the input to the model, and using the dialogue understanding model to predict a corresponding hypernym of each word in the query in the knowledge graph. For example, if one character in the query is “ [symbol] ”, a hyponym where “ [symbol] ” lies is for example “ [symbol] ” in the knowledge graph, and a hypernym of “ [symbol] ” is “location”, the label “location” may be marked for the character “ [symbol] ”. If one character has a plurality of hypernyms, all hypernyms are marked for this character as labels. The corresponding slot pre-training task may include: taking the query as the input to the model, and using the dialogue understanding model to predict a corresponding hypernym of each word in the query in the knowledge graph. Multiple (corresponding to the number of characters) binary predictions are used upon slot prediction. Being trained with the slot pre-training task, the dialogue understanding model has a slot parsing capability in the pre-training phase.

It may be appreciated that for a distinguishing purpose, the query corresponding to the intent pre-training task may be referred to as a first query, the query corresponding to the slot pre-training task may be referred to as a second query, and the first query is the same as or different from the second query, i.e., the same or different query samples may be employed corresponding to different dialogue understanding pre-training tasks. Certainly, if the dialogue understanding pre-training task includes the intent pre-training task and slot pre-training task simultaneously, the same query sample is generally used as input to simultaneously train a plurality of dialogue understanding pre-training tasks.

In some embodiments, the dialogue understanding training data may be obtained based on the search engine data and/or knowledge graph, and the effect of the dialogue understanding model may be enhanced based on the user's behavior of the search engine and the structured knowledge of the knowledge graph.

Step 102 is illustrated as follows:

At present, to reduce the workload and cost of the model training, optimization adjustment is generally performed on the basis of an already-existing pre-training model, to obtain a desired model. For example, the desired model is obtained in a pre-training+fine-tuning manner.

In the embodiment of the present disclosure, further training may be performed on the basis of the already-existing pre-training model to obtain the dialogue understanding model. Correspondingly, the dialogue understanding model includes a general pre-training layer which is an already-existing pre-training model (or referred to as a general pre-training model). The general pre-training model is for example a BERT model or ERNIE model.

The general pre-training model (or referred to as a general pre-training layer) has its own general pre-training task, for example, a mask prediction task of the BERT model. In the present embodiment, to adapt for the dialogue understanding task, upon training, the training task further includes a dialogue understanding pre-training task. Hence, the training may be performed in a multi-task training manner. The multiple tasks include the abovementioned general pre-training task and a dialogue understanding pre-training task specially adapted for the dialogue understanding task.

In some embodiments, a model specially adapted for the dialogue understanding task may be obtained by training with the dialogue understanding training data and by performing the training of the dialogue understanding pre-training task upon task training.

To facilitate illustration, the dialogue understanding training data is divided into corpus data and tag data corresponding to the corpus data. For example, if the dialogue understanding pre-training task includes an intent pre-training task, the corpus data includes a first query; the tag data includes a name of a website clicked by the user and corresponding to the first query; and/or, if the dialogue understanding pre-training task includes a slot pre-training task, the corpus data includes a second query; the tag data includes: a corresponding hypernym of each character in the second query in the knowledge graph.

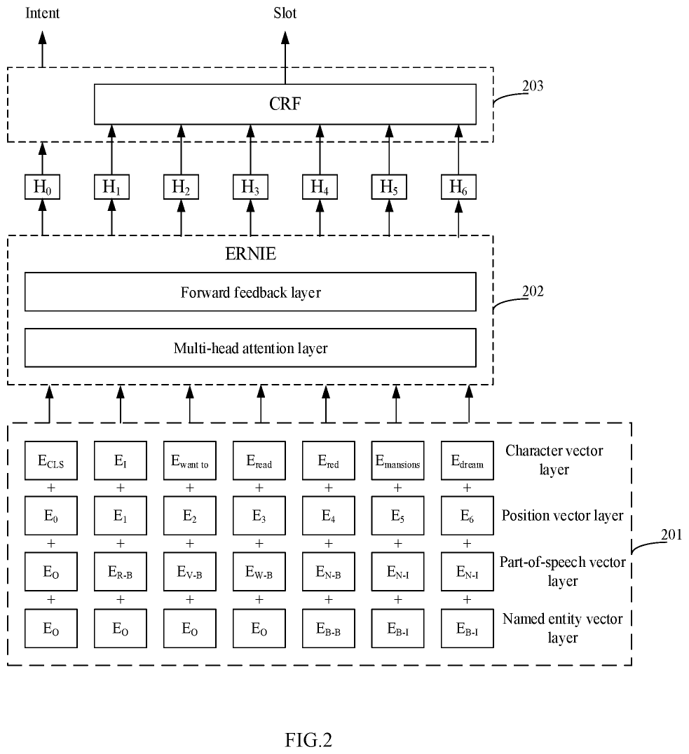

FIG. 2 shows a structural schematic diagram of a dialogue understanding model. Referring to FIG. 2, the dialogue understanding model includes: an input layer 201, a general pre-training layer 202 and an output layer 203, wherein the input to the general pre-training layer 202 is connected to the input layer 201, and the output of the general pre-training layer 202 is connected to the output layer 203. The general pre-training layer 202 employs a general pre-training model structure, for example, the ERNIE model is taken as an example in FIG. 2. The input layer 201 is used to convert input data into input vectors, and the general pre-training layer 202 processes the input vectors. For example, the ERNIE model performs processing such as Multi-Head Attention and Feed Forward processing based on a transformer structure. The output of the general pre-training layer 202 is hidden layer output vectors, which are represented by H₀˜H₆, respectively in FIG. 2. The output layer 203 processes the hidden layer output vectors to obtain output data. Types of the output data vary with tasks. For example, in the embodiment of the present disclosure, the task is a dialogue understanding task, so the output data is data related to the dialogue understanding task. For example, referring to FIG. 2, the output data includes intent data and slot data.

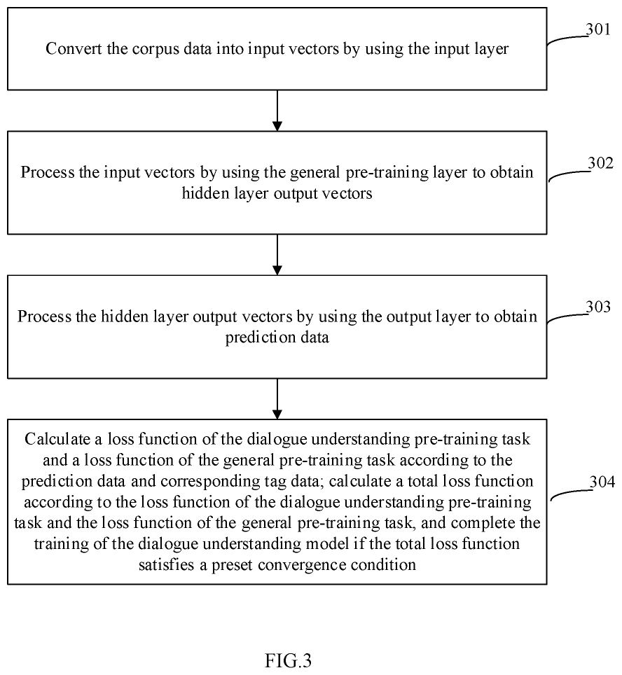

As shown in FIG. 3, the dialogue understanding model includes: an input layer, a general pre-training layer, and an output layer. A process of obtaining the dialogue understanding model by using the dialogue understanding training data to perform joint training of the dialogue understanding pre-training task and the general pre-training task may include:

301: converting the corpus data into input vectors by using the input layer.

302: processing the input vectors by using the general pre-training layer to obtain hidden layer output vectors.

The general pre-training layer may perform general processing such as the aforementioned Multi-Head Attention and Feed Forward processing.

303: processing the hidden layer output vectors by using the output layer to obtain prediction data.

304: calculating a loss function of the dialogue understanding pre-training task and a loss function of the general pre-training task according to the prediction data and corresponding tag data; calculating a total loss function according to the loss function of the dialogue understanding pre-training task and the loss function of the general pre-training task, and completing the training of the dialogue understanding model if the total loss function satisfies a preset convergence condition.

The loss function of each task may employ the loss function in the relevant technology. When the total loss function is calculated, the loss functions of the respective tasks may be directly added or weighted to obtain the total loss function, and the preset convergence condition may be set as needed or employ the convergence condition in the relevant technology. If the total loss function does not meet the convergence condition, model parameters are updated until the convergence condition is met; if the convergence condition is met, the model parameters at this time are regarded as final model parameters to complete the training of the dialogue understanding model.

In the present embodiment, the training of the dialogue understanding pre-training task may be performed based on the corpus data and tag data, to optimize the model parameters.

The step 301 is illustrated as follows:

In the relevant technology, the input layer generally includes a word vector (embedding) layer and a position vector (embedding) layer.

In the present embodiment, in order to improve the adaptability of the dialogue understanding model and the dialogue understanding capability, the input layer further includes: a part-of-speech vector layer; and/or a named entity vector layer.

As shown in FIG. 2, an example is taken in which a part-of-speech vector (embedding) layer and a named entity vector (embedding) layer are added to the input layer. Assuming that the query in FIG. 2 is “I want to read A Dream of Red Mansions”, R (pronoun), V (adverb), W (verb) and N (noun) in the part-of-speech vector layer represent different part-of-speech tags, B of the named entity vector layer is a named entity tag, and O represents it is not a named entity.

In some embodiments, with the part-of-speech vector layer and/or the named entity vector layer being added, tags such as part-of-speech and named entities that are conducive to dialogue understanding may be explicitly modeled, and more priori knowledge may be introduced upon training, to improve the dialogue understanding capability.

Step 303 is illustrated as follows:

As analyzed above, the dialogue understanding task may be divided into multiple tasks (the intent pre-training task and the slot pre-training task), and the dialogue understanding tasks may correspond to different independent output layer models. For example, the intent pre-training task corresponds to a first output layer model, the slot pre-training task corresponds to a second output layer model, the first output layer model is used to input intent data, the second output layer model is used to output slot data, and the first output layer model and the second output layer model are independent on each other, that is, there is no sharing relationship between the first output layer model and the second output layer model. However, the models independent on each other might have a problem about poor overall task performance. For example, when the performance of the first output layer model is better, the performance of the second output layer model is poor.

To achieve optimization of intent classification and slot labeling synchronously, in some embodiments, a shared output layer may be used. That is, referring to FIG. 2, the output layer 203 is a shared layer of the intent pre-training task and the slot pre-training task, and the output data of the output layer 203 includes intent and slot data. Specifically, referring to FIG. 2, the intent corresponds to a hidden layer output vector H₀, and the slot data corresponds to other hidden layer output vectors, such as H₁˜H₆ in FIG. 2. The output layer uses the [CLS] position for intent classification, and other hidden layer output vectors (H1˜H6), after being subjected to Conditional Random Field (CRF) processing, are used for slot labelling. According to different stages of the model, the output data are different types of data. For example, in the training stage, the output data is prediction data (such as intent prediction data or slot prediction data), and in the application stage, the output data is a task processing result (e.g., an intent classification result or a slot labelling result).

In some embodiments, synchronous training of multiple dialogue understanding pre-training tasks may be implemented and the effect of the dialogue understanding model may be optimized in a way that the output layer is shared by multiple dialogue understanding pre-training tasks.

In the present embodiment, a model specially adapted for the dialogue understanding task may be obtained by training with the dialogue understanding training data and by performing the training of the dialogue understanding pre-training task upon task training. With the part-of-speech vector layer and/or the named entity vector layer being added, tags such as part-of-speech and named entities that are conducive to dialogue understanding may be explicitly modeled, and more priori knowledge may be introduced upon training, to improve the dialogue understanding capability. The dialogue understanding training data may be obtained based on the search engine data and/or knowledge graph, and the effect of the dialogue understanding model may be enhanced based on the user's behavior of the search engine and the structured knowledge of the knowledge graph. Synchronous training of multiple dialogue understanding pre-training tasks may be implemented and the effect of the dialogue understanding model may be optimized in a way that the output layer is shared by multiple dialogue understanding pre-training tasks.

Dialogue understanding may be divided into different domains such as intelligent customer service domain, intelligent assistant domain, onboard navigation domain, intelligent home domain etc. It may be appreciated that the above-mentioned domain division manner is just an example, and other domain division manners may also be employed, for example, dialogue understanding may be divided into weather domain, music domain, movie domain etc.

After the dialogue understanding model is trained through the above embodiments, based on the pre-training+fine-tuning idea, the above dialogue understanding model may be taken as a pre-training model (at this time, the dialogue understanding model may be referred to as a general dialogue understanding model) for fine-tuning to obtain dialogue understanding models in various domains.

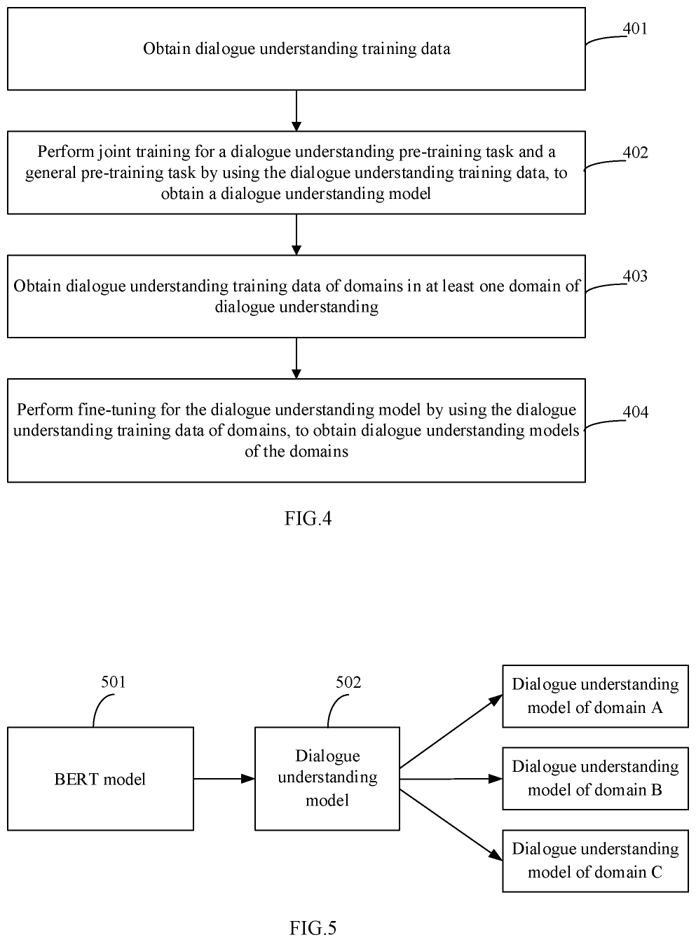

FIG. 4 illustrates a schematic diagram of a fourth embodiment according to the present disclosure. The present embodiment provides a method for training a dialogue understanding model, including:

401: obtaining dialogue understanding training data.

402: performing joint training for a dialogue understanding pre-training task and a general pre-training task by using the dialogue understanding training data, to obtain a dialogue understanding model.

403: obtaining dialogue understanding training data of domains in at least one domain of dialogue understanding.

404: performing fine-tuning for the dialogue understanding model by using the dialogue understanding training data of domains, to obtain dialogue understanding models of the domains.

For example, regarding the intelligent customer service domain, the dialogue understanding training data in the intelligent customer service domain is used to fine-tune the above-mentioned dialogue understanding model to obtain the dialogue understanding model of the intelligent customer service domain. Regarding the onboard navigation domain, the dialogue understanding training data in the onboard navigation domain is used to fine-tune the above-mentioned dialogue understanding model to obtain the dialogue understanding model of the onboard navigation domain

In some embodiments, after the above-mentioned dialogue understanding model is obtained, it may be regarded as a general dialogue understanding model. In subsequent tasks, the dialogue understanding training data in various domains of dialogue understanding may be used to train the general dialogue understanding model again to obtain dialogue understanding models of various domains. In the embodiments of the present disclosure, the training process of obtaining the general dialogue understanding model by training based on the general pre-training model may be referred to as post-training, and the training process of obtaining the dialogue understanding models of various domains by training based on the general dialogue understanding model may be referred to as fine-tuning. Therefore, some embodiments of the present disclosure may provide an overall training process including: pre-training->post-training->fine-tuning.

In relevant technologies, when the dialogue understanding models of various domains are trained, they are obtained by training directly based on a general semantic understanding model. However, since it is difficult to collect data in the domain, a large amount of manual annotation is often required, which is costly and difficult to construct; in addition, after a dialogue understanding model in one domain is constructed, if a dialogue understanding model in another domain is needed, it needs to be obtained by training again based on the general semantic understanding model, with poor universality.

In the embodiment of the present disclosure, referring to FIG. 5, the method includes: 501: training based on a general semantic understanding model (such as a BERT model) to obtain a general dialogue understanding model; 502: training based on the general dialogue understanding model to obtain dialogue understanding models of various domains.

In the present embodiment, the construction cost may be reduced and the universality be improved by obtaining the dialogue understanding models of various domains by training based on the general dialogue understanding model.

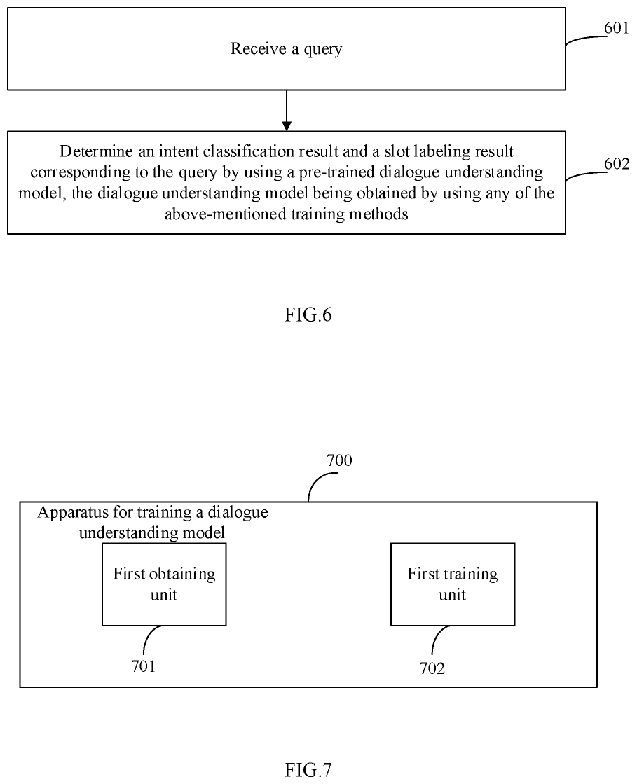

FIG. 6 is a schematic diagram of a sixth embodiment according to the present disclosure. The present embodiment provides a dialogue understanding method, including:

601: receiving a query.

602: determining an intent classification result and a slot labeling result corresponding to the query by using a pre-trained dialogue understanding model; the dialogue understanding model is obtained by using any of the above-mentioned training methods.

For example, if the user interacts with the dialogue understanding system, the user enters the query “I want to read A Dream of Red Mansions”. If A Dream of Red Mansions here refers to a novel, the dialogue understanding system, after having received the query, performs dialogue understanding for it based on the dialogue understanding model obtained previously by training, to obtain that the intent classification result is “searching for a novel”, and the slot labelling result includes “ [symbol] (I)”, “ [symbol] (want to)”, “ [symbol] (read)”, “ [symbol] (red)”, “ [symbol] (mansions)” and “dream( [symbol] )” labelled as “O”, “O”, “O”, “B-Book”, “I-Book” and “I-Book” in turn. “O” means that the character is not any slot, “B-Book” means that the character is the beginning of the slot “ [symbol] (novel)”, and “I-Book” means that the character is of other component of the slot “ [symbol] (novel)”.

In the above process, the user may interact with the dialogue understanding system in the form of a text, a speech, etc., for example, the user uses a speech or a text to input a query, which is not limited in the present disclosure.

The dialogue understanding system may be implemented on a client-server basis, and the client is deployed on the user terminal; the server may be disposed on the server of the dialogue understanding service provider, and the server may be an ordinary server or a cloud server; or, the server may also be disposed locally in the user terminal to implement offline dialogue understanding service. This is not limited in the present disclosure. Examples of the user terminal are also not limited in the present disclosure, for example, the user terminal may be a mobile phone, a tablet computer, a digital assistant, etc. Examples of the client are also not limited in the present disclosure, for example, the client may be an APP, a web page, a program, and so on.

In the present embodiment, the dialogue understanding is performed by using the dialogue understanding model, the dialogue understanding model is obtained in the above-mentioned training manner, and the dialogue understanding effect may be improved.

FIG. 7 is a schematic diagram of a seventh embodiment of the present disclosure. As shown in FIG. 7, the present embodiment provides an apparatus 700 for training a dialogue understanding model, the apparatus comprises: a first obtaining unit 701 and a first training unit 702. The first obtaining unit 701 is configured to obtain dialogue understanding training data; the first training unit 702 is configured to perform joint training for a dialogue understanding pre-training task and a general pre-training task by using the dialogue understanding training data, to obtain a dialogue understanding model.

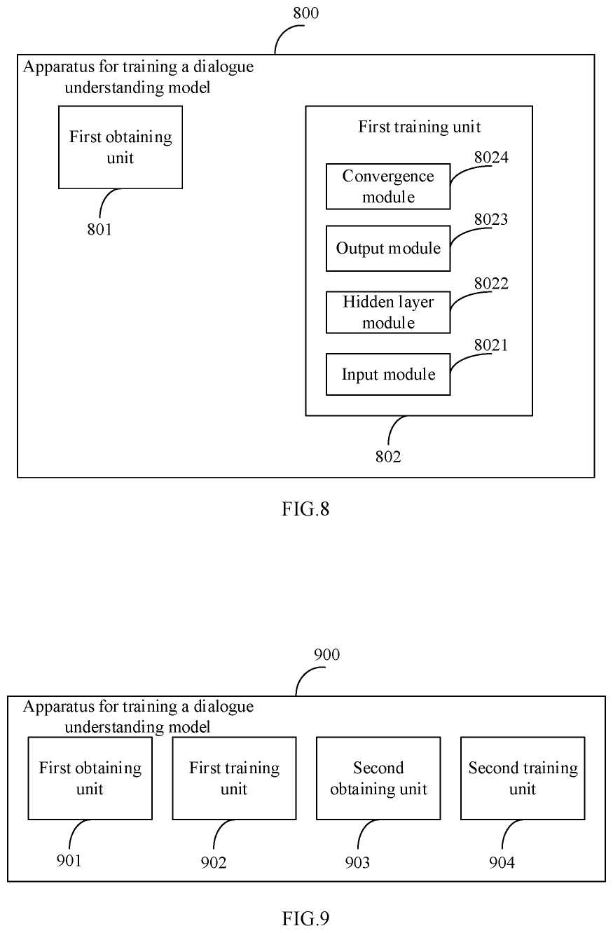

In some embodiments, referring to FIG. 8, an apparatus 800 for training a dialogue understanding model is provided, comprising: a first obtaining unit 801 and a first training unit 802. The first obtaining unit 801 is configured to obtain dialogue understanding training data. The first training unit 802 is configured to perform joint training for a dialogue understanding pre-training task and a general pre-training task by using the dialogue understanding training data, to obtain a dialogue understanding model. The dialogue understanding model comprises: an input layer, a general pre-training layer and an output layer. The dialogue understanding training data comprises: corpus data and tag data corresponding to the corpus data. The first training unit 802 includes an input module 8021, a hidden layer model 8022, an output module 8023 and a convergence module 8024. The input module 8021 is configured to convert the corpus data into input vectors by using the input layer; the hidden layer module 8022 is configured to process the input vectors by using the general pre-training layer to obtain hidden layer output vectors; the output module 8023 is configured to process the hidden layer output vectors by using the output layer to obtain prediction data; the convergence module 8024 is configured to calculate a loss function of the dialogue understanding pre-training task and a loss function of the general pre-training task according to the prediction data and corresponding tag data; calculate a total loss function according to the loss function of the dialogue understanding pre-training task and the loss function of the general pre-training task, and complete the training of the dialogue understanding model if the total loss function satisfies a preset convergence condition.

In some embodiments, the dialogue understanding pre-training task comprises: an intent pre-training task; and/or a slot pre-training task.

In some embodiments, if the dialogue understanding pre-training task includes an intent pre-training task, the corpus data includes a first query; the tag data includes a name of a website clicked by the user and corresponding to the first query; and/or, if the dialogue understanding pre-training task includes a slot pre-training task, the corpus data includes a second query; the tag data includes: a corresponding hypernym of each character in the second query in the knowledge graph.

In some embodiments, if the dialogue understanding pre-training task includes the intent pre-training task and the slot pre-training task, the output layer is a shared layer of the intent pre-training task and the slot pre-training task, and the output data of the output layer includes intent data and slot data.

In some embodiments, the input layer includes: a part-of-speech vector layer; and/or, a named entity vector layer.

In some embodiments, referring to FIG. 9, an apparatus 900 for training a dialogue understanding model is provided, comprising: a first obtaining unit 901 and a first training unit 902, and further comprising: a second obtaining unit 903 and a second training unit 904. The second obtaining unit 903 is configured to obtain dialogue understanding training data of domains in at least one domain of dialogue understanding; the second training unit 904 is configured to perform fine-tuning for the dialogue understanding model by using the dialogue understanding training data of domains, to obtain dialogue understanding models of the domains.

In embodiments, a model specially adapted for the dialogue understanding task may be obtained by training with the dialogue understanding training data and by performing the training of the dialogue understanding pre-training task upon task training. With the part-of-speech vector layer and/or the named entity vector layer being added, tags such as part-of-speech and named entities that are conducive to dialogue understanding may be explicitly modeled, and more priori knowledge may be introduced upon training, to improve the dialogue understanding capability. The dialogue understanding training data may be obtained based on the search engine data and/or knowledge graph, and the effect of the dialogue understanding model may be enhanced based on the user's behavior of the search engine and the structured knowledge of the knowledge graph. Synchronous training of multiple dialogue understanding pre-training tasks may be implemented and the effect of the dialogue understanding model may be optimized in a way that the output layer is shared by multiple dialogue understanding pre-training tasks. The construction cost may be reduced and the universality be improved by obtaining the dialogue understanding models of various domains by training based on the general dialogue understanding model.

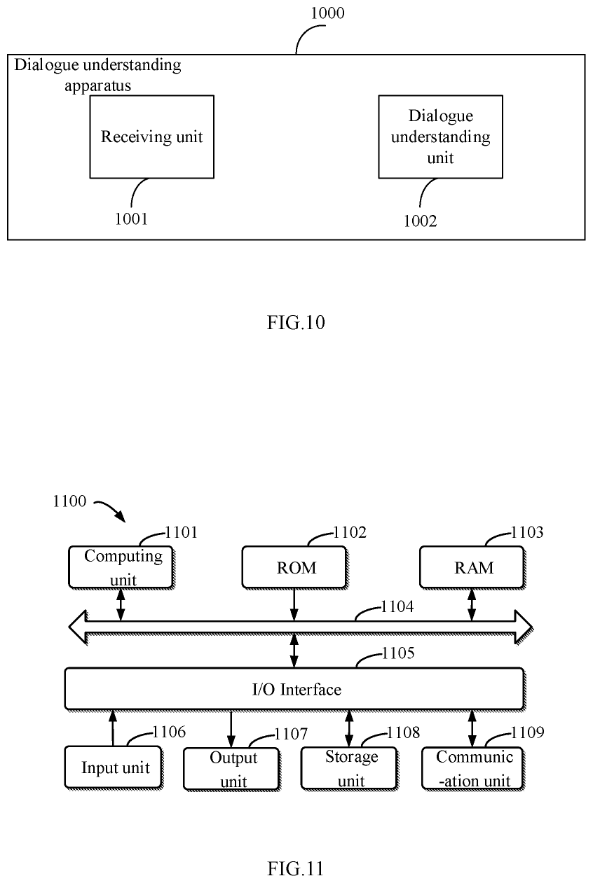

FIG. 10 illustrates a schematic diagram of a tenth embodiment according to the present disclosure. As shown in FIG. 10, the present embodiment provides a dialogue understanding apparatus, comprising a receiving unit 1001 and a dialogue understanding unit 1002. The receiving unit 1001 is configured to receive a query; the dialogue understanding unit 1002 is configured to determine an intent classification result and a slot labeling result corresponding to the query by using a pre-trained dialogue understanding model; the dialogue understanding model is obtained by using any of the above-mentioned training methods.

In the present embodiment, the dialogue understanding is performed by using the dialogue understanding model, the dialogue understanding model is obtained in the above-mentioned training manner, and the dialogue understanding effect may be improved.

According to embodiments of the present disclosure, the present disclosure further provides an electronic device, a readable storage medium and a computer program product.

FIG. 11 illustrates a schematic diagram of an electronic device 1100 for implementing embodiments of the present disclosure. The electronic device is intended to represent various forms of digital computers, such as laptops, desktops, workstations, personal digital assistants, servers, blade servers, mainframes, and other appropriate computers. The electronic device is further intended to represent various forms of mobile devices, such as personal digital assistants, cellular telephones, smartphones, wearable devices and other similar computing devices. The components shown here, their connections and relationships, and their functions, are meant to be exemplary only, and are not meant to limit implementations of the inventions described and/or claimed in the text here.

As shown in FIG. 11, the device 1100 comprises a computing unit 1101 that may perform various appropriate actions and processing based on computer program instructions stored in a read-only memory (ROM) 1102 or computer program instructions loaded from a storage unit 1108 to a random access memory (RAM) 1103. In the RAM 1103, there further store various programs and data needed for operations of the device 1100. The computing unit 1101, ROM 1102 and RAM 1103 are connected to each other via a bus 1104. An input/output (I/O) interface 1105 is also connected to the bus 1104.

Various components in the device 1100 are connected to the I/O interface 1105, including: an input unit 1106 such as a keyboard, a mouse and the like; an output unit 1107 including various kinds of displays and a loudspeaker, etc.; a storage unit 1108 including a magnetic disk, an optical disk, and etc.; a communication unit 1109 including a network card, a modem, and a wireless communication transceiver, etc. The communication unit 1109 allows the device 1100 to exchange information/data with other devices through a computer network such as the Internet and/or various kinds of telecommunications networks.

The computing unit 1101 may be various general-purpose and/or special-purpose processing components with processing and computing capabilities. Some examples of computing unit 1101 include, but are not limited to, Central Processing Unit (CPU), Graphics Processing Unit (GPU), various dedicated artificial intelligence (AI) computing chips, various computing units that run machine learning model algorithms, Digital Signal Processing (DSP), and any appropriate processor, controller, microcontroller, etc. The computing unit 1101 executes various methods and processes described above, such as the method for training a dialogue understanding model or the dialogue understanding method. For example, in some embodiments, the method for training a dialogue understanding model or the dialogue understanding method may be implemented as a computer software program, which is tangibly contained in a machine-readable medium, such as the storage unit 1108. In some embodiments, part or all of the computer program may be loaded and/or installed on the device 1100 via the ROM 1102 and/or the communication unit 1109. When the computer program is loaded into the RAM 1103 and executed by the computing unit 1101, one or more steps of the method for training a dialogue understanding model or the dialogue understanding method described above may be executed. Alternatively, in other embodiments, the computing unit 1101 may be configured in any other suitable manner (for example, with the aid of firmware) to execute the method for training a dialogue understanding model or the dialogue understanding method.

Various implementations of the system and technology described above in the text may be implemented in a digital electronic circuit system, an integrated circuit system, a Field-Programmable Gate Array (FPGA), an Application Specific Integrated Circuit (ASIC), an Application Specific Standard Parts (ASSP), System on Chip (SOC), Complex Programmable Logic Device (CPLD), computer hardware, firmware, software and/or combinations thereof. The various implementations may include: implemented in one or more computer programs which may be executed and/or explained on a programmable system including at least one programmable processor; the programmable processor may be a dedicated or general-purpose programmable processor, may receive data and instructions from a storage system, at least one input device and at least one output device, and transmit the data and instructions to the storage system, the at least one input device and the at least one output device.

The computer program code for implementing the method of the subject matter described herein may be complied with one or more programming languages. These computer program codes may be provided to a general-purpose computer, a dedicated computer or a processor or controller of other programmable data processing apparatuses, such that when the program codes are executed by the processor or controller, the functions/operations prescribed in the flow chart and/or block diagram are caused to be implemented. The program code may be executed completely on a computer, partly on a computer, partly on a computer as an independent software packet and partly on a remote computer, or completely on a remote computer or server.

In the context of the subject matter described herein, the machine-readable medium may be any tangible medium including or storing a program for or about an instruction executing system, apparatus or device. The machine-readable medium may be a machine-readable signal medium or machine-readable storage medium. The machine-readable medium may include, but not limited to, electronic, magnetic, optical, electro-magnetic, infrared, or semiconductor system, apparatus or device, or any appropriate combination thereof. More detailed examples of the machine-readable storage medium include, an electrical connection having one or more wires, a portable computer magnetic disk, a hard drive, a Random-Access Memory (RAM), a Read-Only Memory (ROM), an Erasable Programmable Read-Only Memory (EPROM or flash memory), an optical fiber, a Portable Compact Disc Read-Only Memory (CD-ROM), an optical storage device, a magnetic storage device, or any appropriate combination thereof.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a Local Area Network (LAN), a Wide Area Network (WAN), and the Internet.

The computing system may include clients and servers. A client and server are generally remote from each other and typically interact through a communication network. The relationship of client and server arises by virtue of computer programs running on the respective computers and having a client-server relationship to each other. The server may be a cloud server, also referred to as a cloud computing server or a cloud host, and is a host product in a cloud computing service system to address defects such as great difficulty in management and weak service extensibility in a traditional physical host and VPS (Virtual Private Server). The server may also be a server of a distributed system, or a sever combined with a block chain.

It should be understood that the various forms of processes shown above can be used to reorder, add, or delete steps. For example, the steps described in the present disclosure can be performed in parallel, sequentially, or in different orders as long as the desired results of the technical solutions disclosed in the present disclosure can be achieved, which is not limited herein.

The foregoing specific implementations do not constitute a limitation on the protection scope of the present disclosure. It should be understood by those skilled in the art that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A method for training a dialogue understanding model, comprising:
obtaining dialogue understanding training data; and
performing joint training for a dialogue understanding pre-training task and a general pre-training task by using the dialogue understanding training data, to obtain a dialogue understanding model.

2. The method according to claim 1,
wherein the dialogue understanding model includes:
an input layer,
a general pre-training layer, and
an output layer,
the dialogue understanding training data includes:
corpus data, and
tag data corresponding to the corpus data, and
the step of performing joint training for a dialogue understanding pre-training task and a general pre-training task by using the dialogue understanding training data, to obtain a dialogue understanding model comprises:
converting the corpus data into input vectors by using the input layer;
processing the input vectors by using the general pre-training layer to obtain hidden layer output vectors;
processing the hidden layer output vectors by using the output layer to obtain prediction data;
calculating a loss function of the dialogue understanding pre-training task and a loss function of the general pre-training task according to the prediction data and corresponding tag data;
calculating a total loss function according to the loss function of the dialogue understanding pre-training task and the loss function of the general pre-training task; and
completing the training of the dialogue understanding model if the total loss function satisfies a preset convergence condition.

3. The method according to claim 2, wherein
if the dialogue understanding pre-training task includes an intent pre-training task, the corpus data includes a first query; the tag data includes a name of a website clicked by the user and corresponding to the first query; and/or,
if the dialogue understanding pre-training task includes a slot pre-training task, the corpus data includes a second query; the tag data includes: a corresponding hypernym of each character in the second query in a knowledge graph.

4. The method according to claim 2, wherein
if the dialogue understanding pre-training task includes an intent pre-training task and a slot pre-training task, the output layer is a shared layer of the intent pre-training task and the slot pre-training task, and output data of the output layer includes intent data and slot data.

5. The method according to claim 2, wherein the input layer comprises:
a part-of-speech vector layer; and/or,
a named entity vector layer.

6. The method according to claim 1, wherein the method further comprises:
obtaining dialogue understanding training data of domains in at least one domain of dialogue understanding;
performing fine-tuning for the dialogue understanding model by using the dialogue understanding training data of the domains, to obtain dialogue understanding models of the domains.

7. The method according to claim 2, wherein the method further comprises:
obtaining dialogue understanding training data of domains in at least one domain of dialogue understanding; and
performing fine-tuning for the dialogue understanding model by using the dialogue understanding training data of the domains, to obtain dialogue understanding models of the domains.

8. The method according to claim 3, wherein the method further comprises:
obtaining dialogue understanding training data of domains in at least one domain of dialogue understanding; and
performing fine-tuning for the dialogue understanding model by using the dialogue understanding training data of the domains, to obtain dialogue understanding models of the domains.

9. The method according to claim 4, wherein the method further comprises:
obtaining dialogue understanding training data of domains in at least one domain of dialogue understanding; and
performing fine-tuning for the dialogue understanding model by using the dialogue understanding training data of the domains, to obtain dialogue understanding models of the domains.

10. The method according to claim 5, wherein the method further comprises:
obtaining dialogue understanding training data of domains in at least one domain of dialogue understanding; and
performing fine-tuning for the dialogue understanding model by using the dialogue understanding training data of the domains, to obtain dialogue understanding models of the domains.

11. An electronic device, comprising:
at least one processor; and
a memory communicatively connected with the at least one processor;
wherein the memory stores instructions executable by the at least one processor, and the instructions are executed by the at least one processor to enable the at least one processor to perform a method for training a dialogue understanding model, wherein the method comprises:
obtaining dialogue understanding training data; and
performing joint training for a dialogue understanding pre-training task and a general pre-training task by using the dialogue understanding training data, to obtain a dialogue understanding model.

12. The electronic device according to claim 11,
wherein the dialogue understanding model includes:
an input layer,
a general pre-training layer, and
an output layer,
the dialogue understanding training data includes:
corpus data, and
tag data corresponding to the corpus data, and
the step of performing joint training for a dialogue understanding pre-training task and a general pre-training task by using the dialogue understanding training data, to obtain a dialogue understanding model comprises:
converting the corpus data into input vectors by using the input layer;
processing the input vectors by using the general pre-training layer to obtain hidden layer output vectors;
processing the hidden layer output vectors by using the output layer to obtain prediction data;
calculating a loss function of the dialogue understanding pre-training task and a loss function of the general pre-training task according to the prediction data and corresponding tag data;
calculating a total loss function according to the loss function of the dialogue understanding pre-training task and the loss function of the general pre-training task; and
completing the training of the dialogue understanding model if the total loss function satisfies a preset convergence condition.

13. The electronic device according to claim 12, wherein
if the dialogue understanding pre-training task includes an intent pre-training task, the corpus data includes a first query; the tag data includes a name of a website clicked by the user and corresponding to the first query; and/or,
if the dialogue understanding pre-training task includes a slot pre-training task, the corpus data includes a second query; the tag data includes: a corresponding hypernym of each character in the second query in a knowledge graph.

14. The electronic device according to claim 12, wherein
if the dialogue understanding pre-training task includes an intent pre-training task and a slot pre-training task, the output layer is a shared layer of the intent pre-training task and the slot pre-training task, and output data of the output layer includes intent data and slot data.

15. The electronic device according to claim 12, wherein the input layer comprises:
a part-of-speech vector layer; and/or,
a named entity vector layer.

16. The electronic device according to claim 11, wherein the method further comprises:
obtaining dialogue understanding training data of domains in at least one domain of dialogue understanding; and
performing fine-tuning for the dialogue understanding model by using the dialogue understanding training data of the domains, to obtain dialogue understanding models of the domains.

17. The electronic device according to claim 12, wherein the method further comprises:
obtaining dialogue understanding training data of domains in at least one domain of dialogue understanding; and
performing fine-tuning for the dialogue understanding model by using the dialogue understanding training data of the domains, to obtain dialogue understanding models of the domains.

18. The electronic device according to claim 13, wherein the method further comprises:
obtaining dialogue understanding training data of domains in at least one domain of dialogue understanding; and
performing fine-tuning for the dialogue understanding model by using the dialogue understanding training data of the domains, to obtain dialogue understanding models of the domains.

19. The electronic device according to claim 14, wherein the method further comprises:
obtaining dialogue understanding training data of domains in at least one domain of dialogue understanding; and
performing fine-tuning for the dialogue understanding model by using the dialogue understanding training data of the domains, to obtain dialogue understanding models of the domains.

20. A non-transitory computer readable storage medium with computer instructions stored thereon, wherein the computer instructions are used for causing a computer to perform a method for training a dialogue understanding model, wherein the method comprises:
obtaining dialogue understanding training data; and
performing joint training for a dialogue understanding pre-training task and a general pre-training task by using the dialogue understanding training data, to obtain a dialogue understanding model.
